(19) United States
(12) Patent Application Publication
(10) Pub. No.: US 2017/0222441 A1
(43) Pub. Date: Aug. 3, 2017

(54) MAXIMUM POWER POINT TRACKING DEVICE AND EVALUATION METHOD FOR PHOTOVOLTAIC MODULE

(71) Applicant: UKC Electronics (H.K.) Co., Ltd., Kowloon (HK)

(72) Inventors: Jin-Syung Chen, Kowloon (HK); Pei-Chin Lin, Kowloon (HK); Jui-Kang Chiang, Kowloon (HK); Lai-Pheng Gan, Kowloon (HK); Chin-Yin Lee, Kowloon (HK); Osamu Nishimaniwa, Kowloon (HK); Katsushi Suzuki, Kowloon (HK)

(21) Appl. No.: 15/164,758

(22) Filed: May 25, 2016

Related U.S. Application Data
(63) Continuation of application No. PCT/CN2016/070329, filed on Jan. 7, 2016.

(30) Foreign Application Priority Data
Nov. 7, 2014 (JP) 2014-227501

(51) Int. Cl. H02J 3/38

(52) U.S. Cl. CPC H02J 3/385

(57) ABSTRACT

A maximum power point tracking device and evaluation method for a photovoltaic module are discloses in which the maximum power point tracking (“MPPT”) device may include an MPPT control unit configured to track a maximum power point with respect to one of voltage, current, and power to control a corresponding one of the voltage, current, and power according to the tracked maximum power point. The device may further include an adjustment unit configured to adjust a loading value according to a measured value in association with an operation or an environment of a photovoltaic module for the MPPT control unit to track the maximum power point.

### PRIORITY CLAIMS/RELATED APPLICATIONS

This application is a national stage application and claims priority under 35 USC 120 and 35 USC 365 and is a continuation of PCT/CN2016/070329, filed Jan. 7, 2016 which in turn claims priority to Japanese Patent Application No. 2014-227501 filed on Nov. 7, 2014, the entirety of both of which are incorporated herein by reference.

### FIELD

The disclosure relates to a maximum power point tracking device and a method for evaluating a photovoltaic module.

### BACKGROUND

FIG. 1 illustrates the current-voltage characteristic curve or the I-V curve, which represents the relationship between electric current and voltage of a typical photovoltaic cell (PV cell). The electric power of the PV cell is the product of the current I and the voltage V. The electric power derived from the characteristic curve of FIG. 1 is not a sole fixed value. Such electric power may be plotted as a power-voltage curve (P-V curve) that varies with change in the voltage V. The point at which the PV cell outputs its maximum power is called a maximum power point. This maximum power point (see “Pmax” in FIG. 1) needs to be tracked in order for the output point of the electrical power of the PV cell to meet a point closest to the maximum power pint to maintain optimal power generation efficiency of the PV cell.

Known and existing systems and methods propose a maximum power point tracking circuit (hereinafter called an “MPPT circuit”) as a device to track the maximum power point to determine the point at which the PC cell actually outputs the electric power to meet the point closest to the maximum power point. Such a maximum power point tracking circuit is configured to fluctuate an operating point of the PV cell to track the maximum power point Pmax. FIG. 2 illustrates a MPPT circuit 20 disposed between an array of photovoltaic modules (PV modules) 10 and a loading 15 that consumes the power output from the array of the PV modules 10. The MPPT circuit 20 is configured to adjust operating voltages of the PV modules 10 in order to output the maximum power from the PV modules 10.

### BRIEF DESCRIPTION OF THE DRAWINGS

FIG. 1 is a diagram illustrating the I-V characteristic curve and the P-V characteristic curve of a photovoltaic (PV) cell;

FIG. 2 is a diagram illustrating a configuration example of a photovoltaic power generation system that employs an MPPT circuit to track the maximum power point of the PV cells;

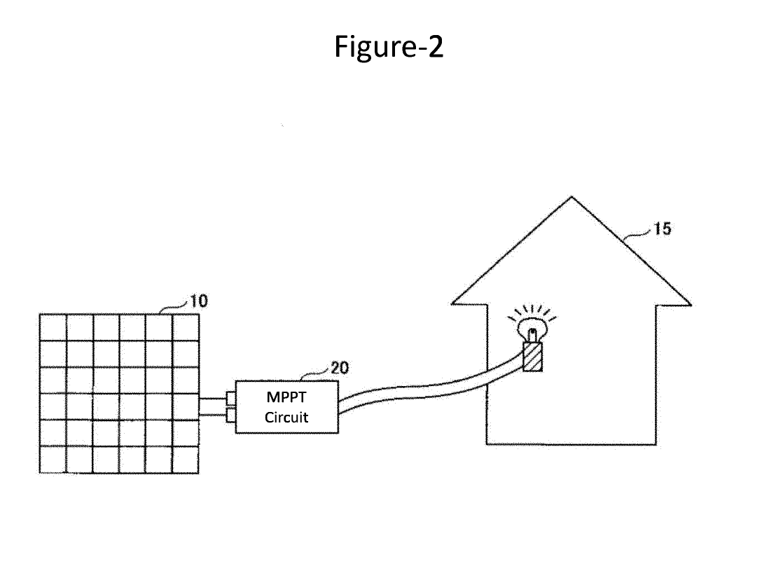

FIG. 3 is a diagram illustrating a measurement device configured to measure the maximum power point tracking efficiency (MPPT tracking efficiency) of the PV cells;

FIG. 4 is a graph illustrating an example of an irradiance changing rate and the MPPT tracking efficiency;

FIG. 5 is a graph illustrating an example of a relationship between irradiation intensity and the MPPT tracking efficiency;

FIG. 6 is a graph illustrating an example of an I-V relationship under the low MPPT tracking efficiency;

FIG. 7 is a diagram illustrating a configuration example of the photovoltaic power generation system;

FIG. 8 is a diagram illustrating another configuration example of the photovoltaic power generation system;

FIG. 9 is a diagram illustrating a configuration example of a photovoltaic power generation system according to a first embodiment;

FIG. 10 is a flowchart illustrating an operations example (a maximum power point tracking process) of a maximum power point tracking device according to the first embodiment;

FIG. 11 is a graph illustrating power acquired from a power meter according to the first embodiment, and selection of the loading;

FIG. 12 is a graph illustrating irradiation intensity acquired from an irradiation sensor according to the first embodiment, and selection of the loading;

FIG. 13 is a diagram illustrating an example of an adjustment circuit selection table according to the first embodiment;

FIG. 14 is a diagram illustrating a configuration example of a photovoltaic power generation system according to a second embodiment;

FIG. 15 is a flowchart illustrating an operations example (a maximum power point tracking process) of a maximum power point tracking device according to the second embodiment;

FIG. 16 is a diagram illustrating an example of an adjustment circuit selection table according to the second embodiment;

FIG. 17 is a diagram illustrating a configuration example of a photovoltaic power generation system according to a third embodiment;

FIG. 18 is a flowchart illustrating an operations example (a maximum power point tracking process) of a maximum power point tracking device according to the third embodiment;

FIG. 19 includes diagrams illustrating examples of different I-V characteristic tables according to the third embodiment;

FIG. 20 includes diagrams illustrating examples of the MPPT tracking efficiency of different photovoltaic cell product matrices under environmental conditions according to the third embodiment;

FIG. 21 is a diagram illustrating a configuration example of a photovoltaic power generation system according to a fourth embodiment;

FIG. 22 includes graphs illustrating comparative examples (excluding an automatic loading adjustment unit) of FIG. 23;

FIG. 23 includes diagrams illustrating examples of an effect (auto loading: automatic loading adjustment) according to the first embodiment;

FIG. 24 is a graph illustrating an example of an effect (voltage trimming: operating voltage band adjustment) according to the second embodiment;

FIG. 25 is a graph illustrating an example of a loss value of the MPPT tracking efficiency;

FIG. 26 is a graphs illustrating an example of an effect (MPPT tracking ability compensation: MPPT tracking efficiency compensation) according to the third embodiment; and

FIG. 27 includes diagrams illustrating examples of an effect (non-charge battery type outside power source) according to the fourth embodiment.

### DETAILED DESCRIPTION OF ONE OR MORE EMBODIMENTS

The disclosed device and method addresses limitations of the conventional MPPT devices since the conventional MPPT circuits may fail to make the maximum power point tracking efficiency (hereinafter called the “MPPT tracking efficiency”) closest to 100%, due to factors of electronic circuit design of those of software programs. In light of the above, one aspect of the disclosure relates to providing a maximum power point tracking device and a method for evaluating a photovoltaic cell, which are capable of preventing the MPPT tracking efficiency from degrading under a predetermined condition as well as improving the electrical power output of the PV cell.

For consistency the following reference numbers are used for the following device and system elements/components/units being described below:
1 photovoltaic power generation system
2, 102 maximum power point tracking device
3 MPPT control unit
4 automatic loading-adjustment unit
5 operating voltage adjustment unit
10, 10a photovoltaic (PV) module
20, 120 MPPT circuit
21, 121 power supply
22, 122 control unit
23, 123 loading unit
24, 28 adjustment unit
25a power meter (voltage meter, current meter)
25b irradiation sensor
25c temperature sensor
25 measurement device
27 switching unit
28 adjustment unit
29 DC voltage power source
104 charge battery
241 first adjustment circuit
242 second adjustment circuit
243 third adjustment circuit
281 first adjustment circuit
282 second adjustment circuit
283 third adjustment circuit

According to one embodiment of the disclosure, there is provided a maximum power point tracking device that includes an MPPT control unit configured to track a maximum power point with respect to one of voltage, current, and power to control a corresponding one of the voltage, current, and power according to the tracked maximum power point; and an adjustment unit configured to adjust a loading value according to a measured value in association with an operation or an environment of a photovoltaic module for the MPPT control unit to track the maximum power point.

According to an aspect of the disclosure, a maximum power point tracking device and a method for evaluating a photovoltaic module may be provided that enable the maximum power point tracking device to prevent the maximum power point tracking efficiency (MPPT tracking efficiency) from degrading under a predetermined condition as well as improving the electrical power output of the PV cell.

The following description illustrates embodiments of the device and method with reference to the accompanying drawings. Note that elements having substantially the same functions or features may be given the same reference numerals and overlapping descriptions thereof may be omitted. Also note that the scope of the disclosure is not limited to the embodiments disclosed below since those embodiments are merely illustrative.

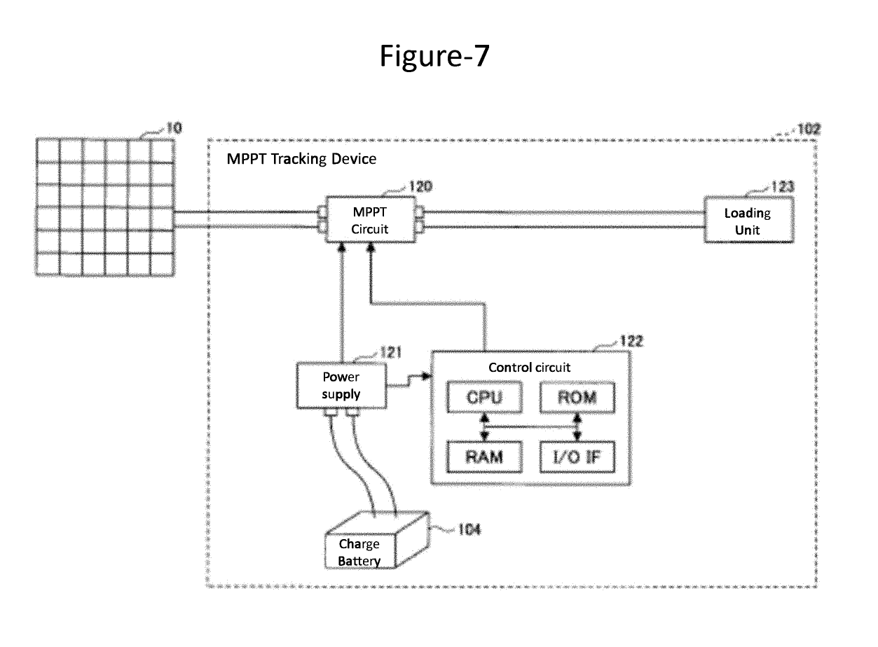

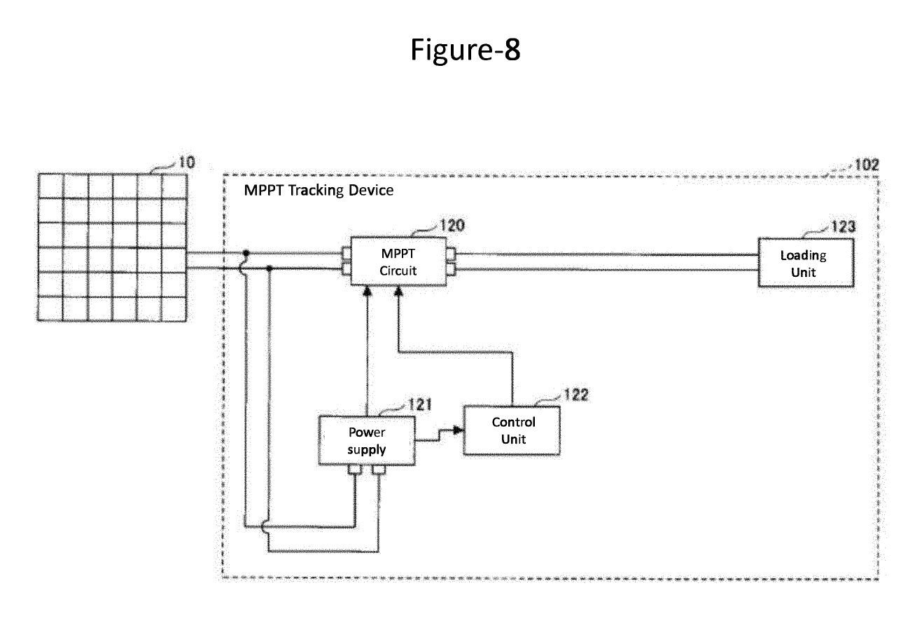

Initially, a configuration of a maximum power point tracking device (hereinafter simply called “MPPT tracking device”) 102 is described with reference to FIGS. 7 and 8. The MPPT tracking device 102 includes an MPPT circuit 120, a power supply 121, a control circuit 122, a loading unit 123, and a charge battery 104. The control circuit 122 may be composed of software or a control element. The control circuit 122 includes a processor, such as a central processing unit (CPU), a read only memory (ROM), a random access memory (RAM), and an input/output interface. The control circuit 122 is configured to control tracking of the maximum power point of a photovoltaic (PV) cell by following instructions set by a maximum power point tracking program (hereinafter called “MTTP tracking program”) stored in the RAM and executed by the processor of the control circuit 122.

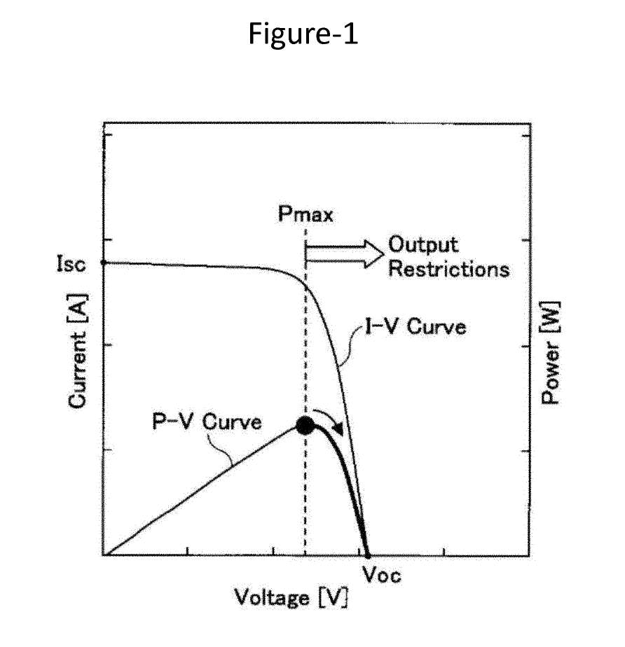

The control circuit 122 is configured to calculate a voltage V closest to the maximum power point Pmax (shown for example in FIG. 1) using, for example, a known hill climbing method, and output the calculated voltage V to the MPPT circuit 120 as an optimal operating point of photovoltaic modules (hereinafter called “PV modules”) 10. The MPPT circuit 120 is configured to raise or lower the voltage based on the control of the control circuit 122 to adjust the voltage output from the PV modules 10 to the voltage V closest to the maximum power point.

The power supply 121 is configured to supply necessary power to the MPPT circuit 120 and the control circuit 122. The power supplied from the power supply 121 may be obtained from a charge battery 104 as illustrated in FIG. 7, or a part of the power generated by the PV modules 10 as illustrated in FIG. 8.

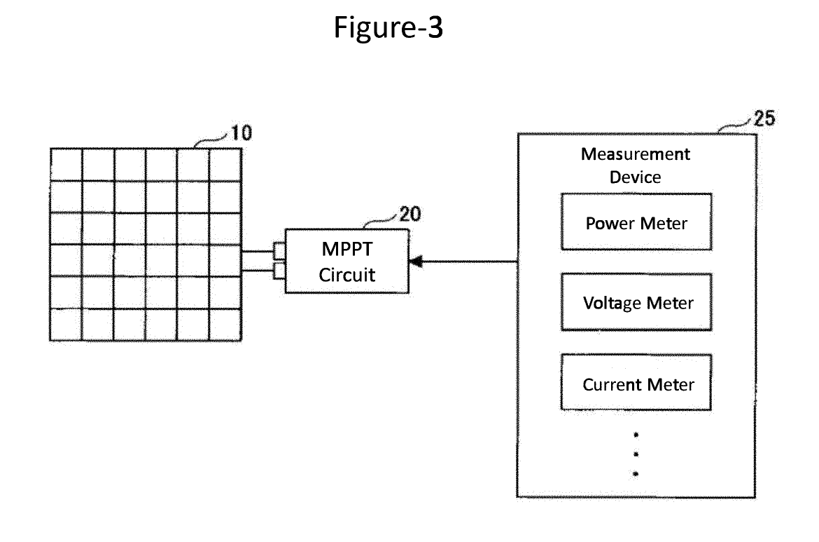

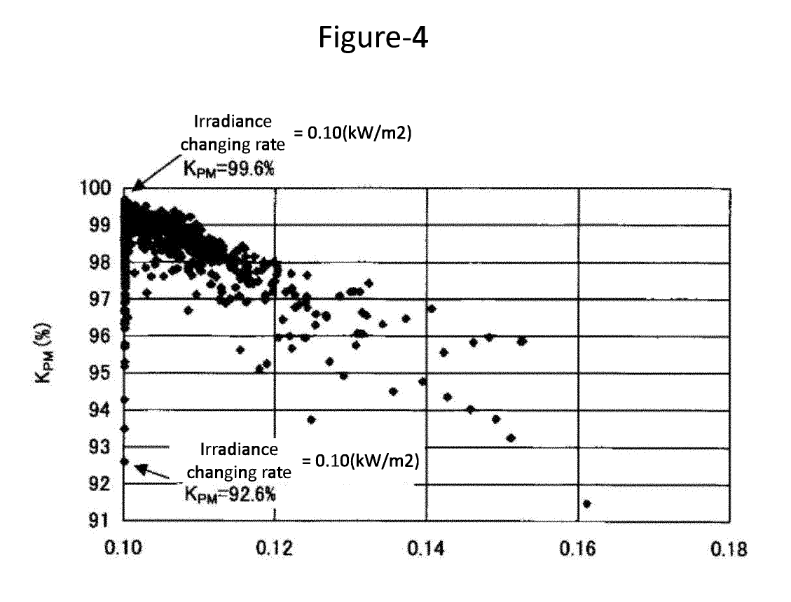

It may be ideal in the maximum power point tracking (MTTP tracking) to track the maximum power point in a current-voltage characteristic curve (I-V curve) regardless of irradiation intensity change. However, the maximum power point tracking efficiency (MPPT tracking efficiency) will not reach 100% in the MPPT tracking device 102 illustrated in FIGS. 7 and 8, due to factors deriving from an electronic circuit design or software programs including a fixed loading unit. FIG. 3 illustrates a measurement device 25 including a power meter, a voltage meter, and a current meter that may be connected to the MPPT circuit 20. The MPPT circuit 20 may in turn be connected to the PV modules 10 as shown in FIG. 3. FIG. 4 illustrates an example of the MPPT tracking efficiency, K_{PM}, when the measurement device 25 in FIG. 3 measures the power output from the MPPT circuit 20 for the MPPT circuits 20 shown in FIGS. 7 and 8. In FIG. 4, a horizontal axis indicates an irradiance changing rate kW/m² and a vertical axis indicates the MTTP tracking efficiency K_{PM} (%). As illustrated in FIG. 4, the MTTP tracking efficiency K_{PM} fluctuates from 92.6 to 99.6% and does not reach 100% even through the irradiance changing rate remain unchanged as 0.10 kW/m².

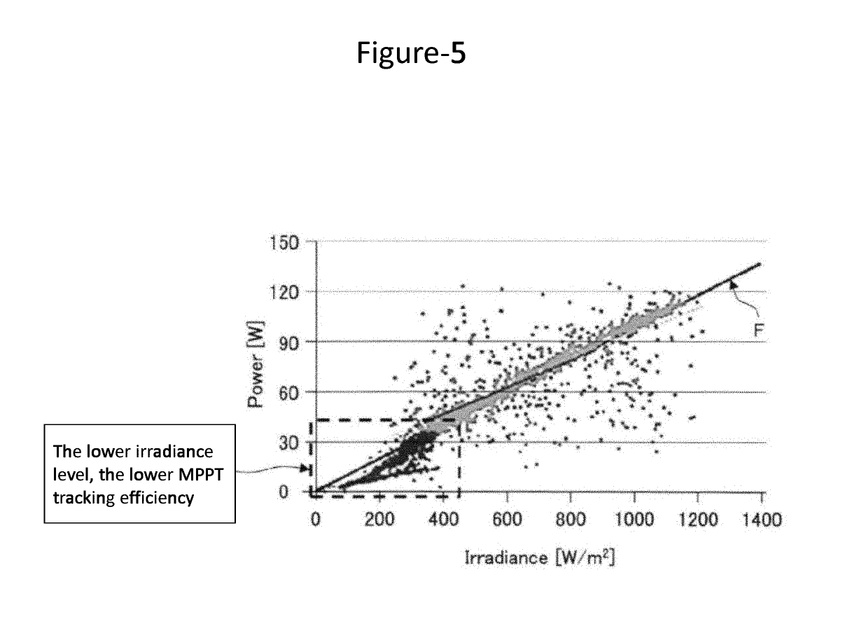

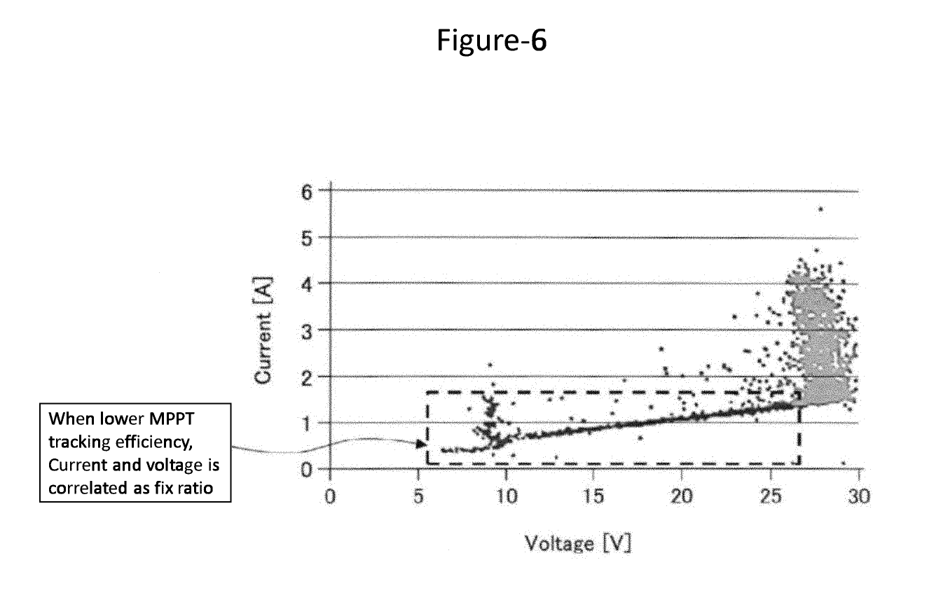

FIG. 5 illustrates examples of experimental results in association with a relationship between the irradiation intensity on the solar module and the MPPT tracking efficiency. The results illustrate that there is a proportional relationship between the irradiation intensity and the MPPT tracking efficiency indicated by a straight line F of FIG. 5 when the irradiation intensity is 400 W/m² or above. On the other hand, under the low irradiance level of the irradiation intensity (400 W/m² or lower) which is illustrated within a box of FIG. 5, the MPPT efficiency has lowered compared to the above case of the irradiation intensity being 400 W/m² or above. Further, the analytic result indicates, as illustrated in a box of FIG. 6, that the voltage V and the current I are maintained at a certain fixed ratio when the MPPT efficiency lowers. This exhibits different characteristics from those of the MPPT efficiency obtained in a case of the irradiation intensity being 400 W/m² or above. In other words, the MPPT circuit may have desired or undesired values in accordance with the input voltage or current.

To summarize the above, the MPPT control performed by the MPPT tracking device 102 may have following problems (1) to (4).

(1) The MPPT tracking efficiency may be lower because loading of the MPPT tracking device 102 is restricted under the irradiation conditions.

(2) The MPPT tracking efficiency may be lower because the operating voltage band accompanied with the MPPT tracking is restricted in each voltage range of the MPPT tracking device 102.

(3) The MPPT tracking efficiency may vary in the MPPT tracking device 102 when electrical conditions of the PV modules 10 are changed. In addition, it may be difficult to specify the MPPT tracking characteristics of the MPPT tracking device 102 that is combined with PV cells having various characteristics.

(4) The MPPT tracking efficiency may be lower due to the internal configuration of the MPPT tracking device 102, such as an electronic circuit design, unstable power supply, and internal loss.

The following embodiments of the photovoltaic power generation system may solve at least one of the above problems to prevent the MPPT tracking efficiency from lowering under a predetermined condition and improve the output power of the PV cells.

### First Embodiment—Photovoltaic Power Generation System

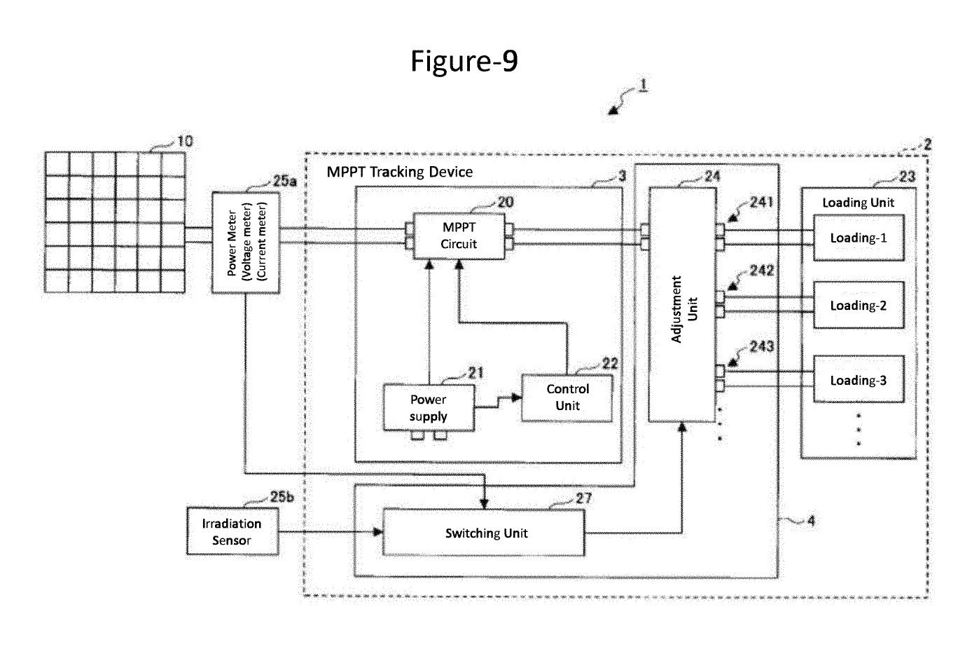

The following illustrates a configuration example of a photovoltaic power generation system 1 according to a first embodiment with reference to FIG. 9. The photovoltaic power generation system 1 according to the first embodiment may be applied not only to a system having a single photovoltaic module (PV module) 10, but also to a large-scale system having multiple PV modules 10. Similarly, a later-described photovoltaic power generation system 1 according to other embodiments may also be applied to a system having a single PV module 10 as well as a large-scale system having multiple PV modules 10.

The photovoltaic power generation system 1 according to the first embodiment includes an automatic loading-adjustment unit 4 configured to automatically adjust loading(s) of the MPPT tracking device 2 so as not to restrict the loading(s) used by the MPPT tracking device 2. The MPPT tracking device 2 according to the first embodiment having such a configuration may improve the MPPT tracking efficiency to prevent the MPPT tracking efficiency of the PV modules 10 being reduced under the predetermined conditions. In the photovoltaic power generation system 1 according to the first embodiment, the MPPT tracking device 2 configured to track the maximum power point of the PV modules 10 is connected to the PV modules 10.

The PV module 10 of the system 1 is configured to convert radiation energy received from the sun into electric energy. The PV module 10 may be a minimum unit of the PV cell (a sheet of the PV module), or a solar panel having multiple PV modules arranged in an array. The PV module 10 may be formed of amorphous silicon, microcrystalline silicon, polysilicon, monocrystalline silicon, or compound semiconductor.

The MPPT tracking device 2 of the first embodiment may include an MPPT control unit 3, an automatic loading-adjustment unit 4, and a loading unit 23 that has one or more loadings, such as Loading-1, Loading-2, Loading-3, . . . as shown in FIG. 9. The MPPT control unit 3 may further include an MPPT circuit 20, a power supply 21, and a control unit 22. The control unit 22 may be composed of software or a control element. The control unit 22 includes a processor, such as a central processing unit (CPU), a read only memory (ROM) and a random access memory (RAM), and is configured to control tracking of the maximum power point of PV modules 10 by following instructions set in a maximum power point tracking program (hereinafter called “MTTP tracking program”) stored in the RAM and executed by the processor. The control unit 22 may be implemented by software or hardware.

The control unit 22 is configured to calculate a voltage V that is closest to the maximum power point Pmax using, for example, a hill climbing method, and output the calculated voltage V to the MPPT circuit 20 as an optimal operating point of the PV modules 10. The MPPT circuit 20 is configured to adjust, using such as a DC-DC converter, the voltage output from the PV modules 10 to the voltage V closest to the maximum power point, based on the control of the control unit 22. The power supply 21 is configured to supply necessary power to the MPPT circuit 20 and the control unit 22.

The MPPT circuit 20 may employ a known configuration such as one illustrated in JP Unexamined Patent Application Publication No. 2012-124991 which is incorporated herein by reference. However, the configuration of the MPPT circuit 20 is not limited to that disclosed in JP Unexamined Patent Application Publication No. 2012-124991 and the MPPT circuit 20 may employ any configuration insofar as such a configuration is capable of tracking the maximum power point of the PV modules 10. The automatic loading-adjustment unit 4 may include an adjustment unit 24 and a switching unit 27. In one embodiment, each of the adjustment unit 24 and the switching unit 27 is implemented in hardware (electrical circuits) and software to perform the operations of the adjustment unit and the switching unit as described below. The adjustment unit 24 may include a first adjustment circuit 241, a second adjustment circuit 242, a third adjustment circuit 243, . . . that couple the different loadings to the MPPT circuit 20. The loading unit 23 combines a loading 1, a loading 2, a loading 3, . . . having different impedances in accordance with the first adjustment circuit 241, the second adjustment circuit 242, the third adjustment circuit 243, . . . . The switching unit 27 is configured to control switching between the first adjustment circuit 241, the second adjustment circuit 242, the third adjustment circuit 243, . . . of the adjustment unit 24. In one implementation, the switching unit 27 may be a microprocessor or microcontroller that executes a plurality of lines of computer code to collect irradiance value for the known irradiance 25b, determine a range in which the irradiance value falls (as described below in the example) and determine which loading to use based on the irradiance value or the irradiance value range as shown in the example below. The switching unit 27 may be connected to an irradiation sensor 25b as shown in FIG. 9. The switching unit 27 also may be connected to a DC power meter 25a (a voltage meter, or a current meter) disposed between the PV modules 10 and the MPPT circuit 20.

For example, for the circuit in FIG. 9, the following example values may be used:

| Switching Program | Irradiance Value | | Loading Value |
|---|---|---|---|
| 241 | <200 | W/m2 | 200 Ω |
| 242 | 200-600 | W/m2 | 100 Ω |
| 243 | >600 | W/m2 | 50 Ω |

As a result of the above example values, the efficiency of the MPPT in FIG. 9 may be:

| Loading Value | <200 W/m2 | 200-600 W/m2 | >600 W/m2 |
|---|---|---|---|
| 200 Ω | >99% | <80% | <50% |
| 100 Ω | 50-80% | >99% | <80% |
| 50 Ω | <50% | <80% | >99% |

### First Embodiment Operations

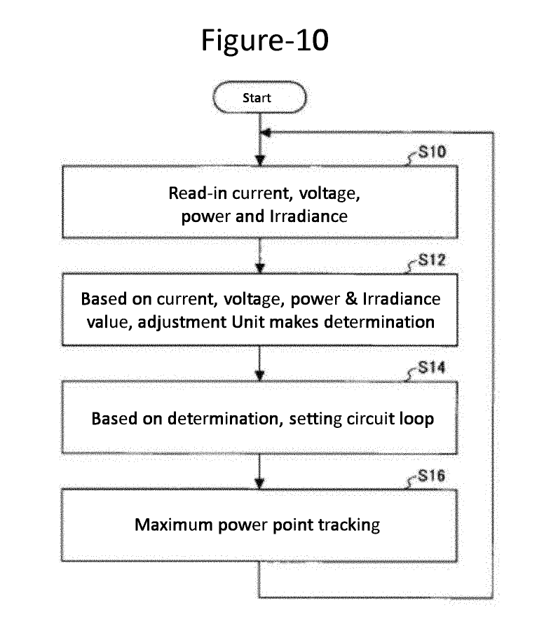

The following illustrates operations of the MPPT tracking device 2 according to the first embodiment with reference to FIG. 10. FIG. 10 illustrates an example of a maximum power point tracking process (MPPT tracking process) executed by the MPPT tracking device 2 according to the first embodiment. The various processes of the method may be performed by the control unit 22, the adjustment unit 24, the switching unit 27 and the MPPT circuit 20 shown in FIG. 9. The example in FIG. 10 uses the same examples values for the irradiance value ranges and loading value described above.

When the MPPT tracking process starts, the DC power meter (voltage meter or current meter) 25a detects the power (a voltage and/or a current) output from the PV modules 10. The irradiation sensor 25b detects the irradiation intensity of the sun on the PV module(s). The irradiation intensity indicates the amount of radiation energy received by a unit area per unit time of the PV module. The results detected by the DC power meter (voltage meter or current meter) 25a and/or the irradiation sensor 25b may be transmitted to and received by the switching unit 27 (S10). For example, the values may be 1.0 A current, 28V voltage, 28 W power and 150 W/m2 irradiance as measured by the irradiance sensor 25b.

Once the data is received, the switching unit 27 may determine a desired adjustment circuit 241-243 to be connected to an appropriate loading according to the acquired power, voltage, current, or irradiation intensity (S12). The switching unit 27 transmits the determined result to the adjustment unit 24. In one example, if the current, voltage and power values are normal (which they are in the example above), the switching unit 27 select switching program 241 (see example above) and determines the loading value to be 200Ω.

The adjustment unit 24 may switch connections between the first adjustment circuit 241, the second adjustment circuit 242, the third adjustment circuit 243, . . . according to the determined result from the switching unit 27 (S14). The first adjustment circuit 241, the second adjustment circuit 242, the third adjustment circuit 243, or other adjustment circuits may be set accordingly, and the loading 1, loading 2, the loading 3, or other loadings may be connected to the MPPT circuit 20 corresponding to the first adjustment circuit 241, the second adjustment circuit 242, the third adjustment circuit 243, or other adjustment circuits. In the above example, if the current loading is already 200Ω, then no switching occurs, but if the current loading is not 200Ω, then the switching unit switches the loading to 200Ω.

The control unit 22 may calculate, using, for example, a hill climbing method, the voltage V closest to the maximum power point Pmax based on the current-voltage characteristic curve (I-V curve, hereinafter called “I-V characteristic curve”) of the PV module 10, in accordance with the power, the voltage, or the current detected by the DC power meter (the voltage meter or the current meter) 25a (S16). The control unit 22 outputs the calculated voltage V to the MPPT circuit 20 as an optimal operating point of the PV module 10. Note that the I-V characteristic curve indicates power generation characteristic of the PV module 10.

The MPPT circuit 20 adjusts the voltage output from the PV modules 10 to the voltage V calculated as a voltage closest to the maximum power point, based on the control of the control unit 22. The control unit 22 constantly adjusts the MPPT circuit 20 so as to track the maximum power point of the power generated by the PV modules 10. The power supply 21 supplies necessary power for operations of the control unit 22 and the MPPT circuit 20.

In the example above, when the loading is changed to 200Ω, the current, voltage and power of the PV module is again tracked by the MPPT tracking device 2 and those values, in this example, are 1.1 A current, 29V voltage and 31.9 W power. Thus, at the irradiance of 150 W/m2, the PV module has a power output of 31.9 W which is better than the 28 W with the original loading. The MPPT tracking device 2 according to the first embodiment may repeat executing the processes of the method in FIG. 10 in accordance with a measured value detected by the DC power meter (the voltage meter or the current meter) 25a or the irradiation sensor 25b. The above-described process may improve the MPPT efficiency in the power generated by the PV modules 10.

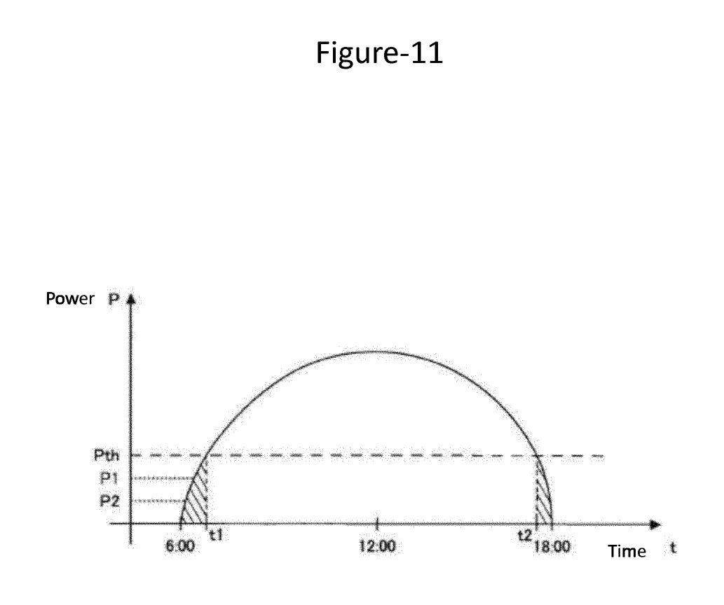

The MPPT efficiency may lower due to the lower irradiance level (low irradiation intensity). For example, as illustrated in FIG. 11, irradiation intensity is low in a sunrise time period such as 6:00 to time t, or a sunset time period such as time t2 to 18:00, which may make it difficult for the MPPT control unit 3 to control the voltage of the PV modules 10. The power P acquired from the PV modules 10 may fail to track the power Pmax of the maximum power point, thereby degrading the MPPT tracking efficiency.

In order to overcome such difficulties, the first embodiment has the following configuration in which, when the power P1 or P2 is detected by the DC power meter 25a indicating the power lower than a predetermined power threshold Pₜₕ (as shown in FIG. 11), the switching unit 27 may determine the irradiation intensity to be a low irradiance level. The switching unit 27 subsequently selects one of the first adjustment circuit 241, the second adjustment circuit 242, the third adjustment circuit 243, and other second adjustment circuits for changing the setting of a loading value according to the power detected by the DC power meter 25a based on the determined result, thereby switching the current adjustment circuit to the selected adjustment circuit. In on example, the loadings may be 300Ω at an irradiance value of <400 W/m2 and 150Ω at an irradiance value of >400 W/m2.

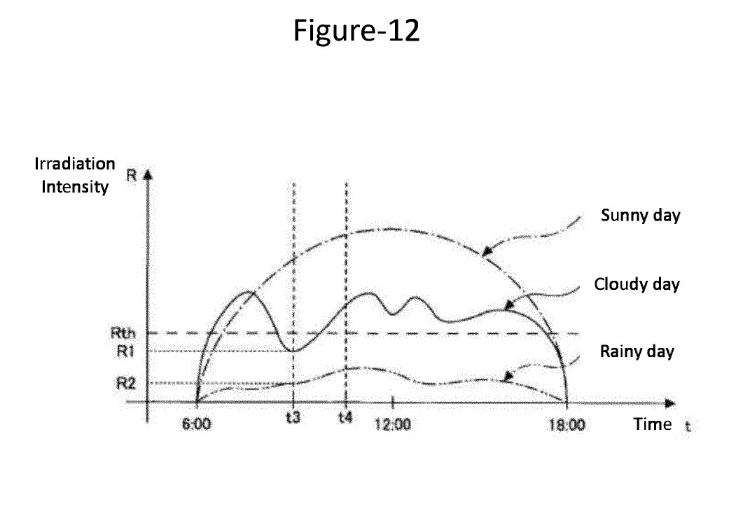

For example, FIG. 12 illustrates the time at which the irradiation intensity R lowers differing between the sunny day, the cloudy day, or the rainy day, which may make it difficult for MPPT control unit 3 to control the voltage of the PV modules 10. The power P acquired from the PV modules 10 may fail to track the power Pmax of the maximum power point, thereby degrading the MPPT tracking efficiency. Hence, the switching unit 27 determines that the irradiation intensity is at the lower irradiance level when the irradiation intensity R1 or R2 detected by the irradiation sensor 25b is lower than the predetermined irradiation intensity threshold Rₜₕ. In one implementation, R1 may have a value of 150Ω, R2 may have a value of 300Ω and Rth may have a value of 168Ω. The switching unit 27 subsequently selects one of the first adjustment circuit 241, the second adjustment circuit 242, the third adjustment circuit 243, and other second adjustment circuits for raising the loading higher than the loading at the normal irradiation intensity according to the irradiation intensity detected by the irradiation sensor 25b, thereby switching the current adjustment circuit to the selected adjustment circuit. This configuration may be able to acquire a constant voltage to control the voltage despite the output of the PV modules 10 being low current.

The photovoltaic power generation system 1 according to the first embodiment thus enables the switching unit 27 to control switching between the first adjustment circuit 241, the second adjustment circuit 242, the third adjustment circuit 243, . . . of the adjustment unit 24 when the irradiation intensity is low (sunrise or sunset), or the voltage or the current is low. This system 1 may be able to adjust the loading connected to the MPPT circuit 20. As illustrated in FIG. 12, the irradiation intensity R at time t3 on the cloudy day and the irradiation intensity R at time t3 on the rainy day are both lower than the irradiation intensity R on the sunny day at time t3, and are also both lower than a predetermined radiation intensity threshold Rth. The switching unit 27 may thus be allowed to control switching between the first adjustment circuit 241, the second adjustment circuit 242, the third adjustment circuit 243, . . . of the adjustment unit 24 at time 3 on the cloudy day and the rainy day of FIG. 12 in order to change settings of the loading. Similarly, the switching unit 27 may be allowed to control switching between the first adjustment circuit 241, the second adjustment circuit 242, the third adjustment circuit 243, . . . of the adjustment unit 24 in order to change settings of the loading because the irradiation intensity R at time 4 on the rainy day of FIG. 12 is lower than those on the cloudy day and the sunny day. Thus, the first embodiment is able to constantly change the loading settings for the MPPT tracking device 2 depending on different irradiation conditions on different days as shown in FIG. 12.

The MPPT tracking device 2 according to the first embodiment does not restrict the loading of the MPPT tracking device 2 connected to the PV modules 10, which may improve the MPPT tracking efficiency in the PV modules 10. The MPPT tracking device 2 according to the first embodiment may thus improve the MPPT tracking efficiency by adjusting the loading of the MPPT tracking device 2 even under the lower irradiance level similar to the case of the normal irradiation intensity.

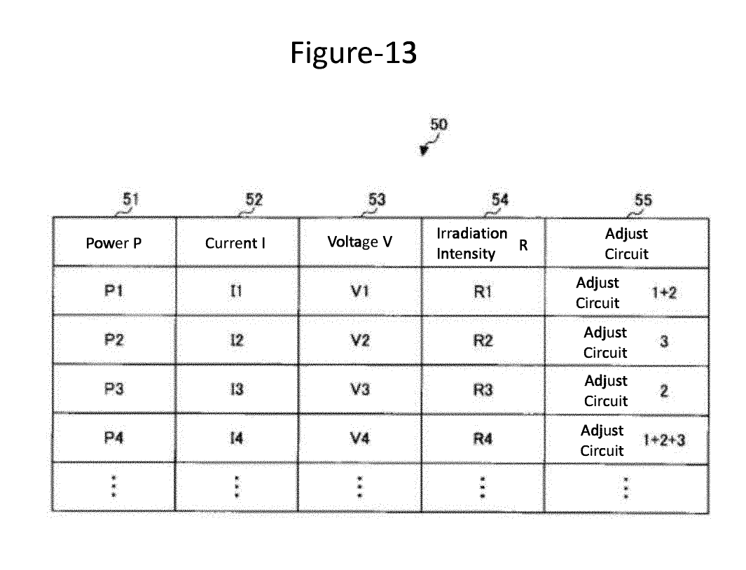

In some embodiments, the MPPT tracking device 2 may have a loading selection table 50 as shown in FIG. 13 stored in the MPPT tracking device 2 that has already stored values for the power P 51, a current I 52, a voltage V 53, an irradiation intensity R 54 and a particular adjustment circuit (or value) 55. The loading selection table 50 may be used by the switching unit 27 in the above described method to adjust the loadings. In some embodiments, the loading selection table may be stored in a memory of the MPPT tracking device 2, such as the RAM or other storage. When the embodiment includes the loading selection table 50, the switching unit 27 may be able to select a desired adjustment circuit 55 from the loading selection table 50 in accordance with the measured power P 51, the current I 52, the voltage V 53 and the irradiation intensity R 54. For example, when the power acquired from the power meter 25a is P1, the switching unit 27 selects a combination of an adjustment circuit 1 and an adjustment circuit 2. The loading value used by the MPPT circuit 20 may thus be the sum of a loading value of the loading 1 and a loading value of the loading 2. The switching unit 27 may be able to select a desired adjustment circuit 55 from the loading selection table 50 in accordance with the acquired current I 52, the voltage V 53, or the irradiation intensity R 54 in a similar fashion.

### Second Embodiment—Photovoltaic Power Generation System

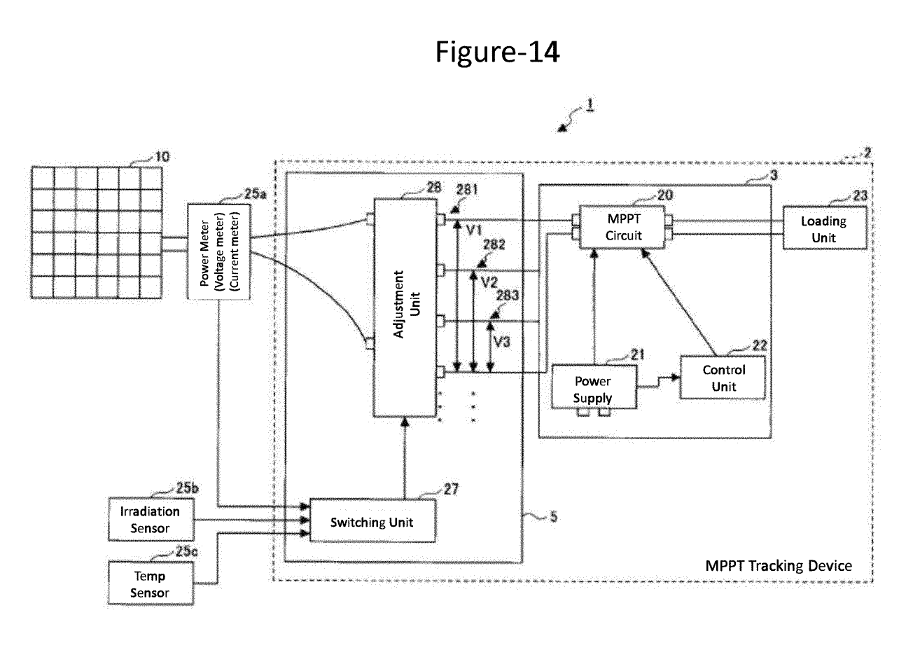

The following illustrates a configuration example of a photovoltaic power generation system 1 according to a second embodiment with reference to FIG. 14. The photovoltaic power generation system 1 according to the second embodiment includes an operating voltage adjustment unit 5 so as not to restrict an operating voltage band accompanied with the maximum power point tracking within each of the voltage ranges. The MPPT tracking device 2 according to the second embodiment having such a configuration may improve the MPPT tracking efficiency to prevent the MPPT tracking efficiency of the PV modules 10 from lowering under the predetermined conditions.

In the photovoltaic power generation system 1 according to the second embodiment, the MPPT tracking device 2 may be configured to track the maximum power point of the PV modules 10. The MPPT tracking device 2 includes an operating voltage adjustment unit 5, an MPPT control unit 3, and a loading unit 23. The MPPT control unit 3 includes an MPPT circuit 20, a power supply 21, and a control unit 22 similar to that of the first embodiment. The control unit 22 may be composed of software or a control element. The control unit 22 is configured to control tracking of the maximum power point of the PV modules 10. The control unit 22 is configured to calculate a voltage V closest to the maximum power point Pmax using, for example, a hill climbing method, and output the calculated voltage V to the MPPT circuit 20 as an optimal operating point of the PV modules 10. The MPPT circuit 20 adjusts the voltage output from the PV modules 10 to the voltage V calculated as a voltage closest to the maximum power point, based on the control of the control unit 22. The power supply 21 is configured to supply necessary power to the MPPT circuit 20 and the control unit 22.

The operating voltage adjustment unit 5 includes an adjustment unit 28 and a switching unit 27. The adjustment unit 28 includes a first adjustment circuit 281, a second adjustment circuit 282, a third adjustment circuit 283, . . . . The first adjustment circuit 281 is configured to shift an operating voltage bandwidth (hereinafter called an “operating voltage band”) of the MPPT circuit 20 by the voltage V1. The second adjustment circuit 282 is configured to shift an operating voltage band of the MPPT circuit 20 by the voltage V2. The third adjustment circuit 283 is configured to shift an operating voltage band of the MPPT circuit 20 by the voltage V3. The switching unit 27 is configured to control switching between the first adjustment circuit 281, the second adjustment circuit 282, the third adjustment circuit 283, . . . of the adjustment unit 28. This configuration enables the switching unit 27 to select one of the first adjustment circuit 281, the second adjustment circuit 282, the third adjustment circuit 283, . . . so as to shift the operating voltage band of the PV modules 10 by different voltage width (V1>V2>V3).

For example, for the circuit in FIG. 14, the following example voltage operating bands for each switching program may be used:

| Switching Program | Operating Voltage Band |
|---|---|
| 281 | 50-60 V |
| 282 | 60-70 V |
| 283 | 70-80 V |

The switching unit 27 is connected to the power meter (voltage meter, current meter) 25a, the irradiation sensor 25b, and the temperature sensor 25c. Note that the measurement device 25 configured to measure operating conditions and environmental conditions of the PV modules 10 is not limited to the power meter (voltage meter, current meter) 25a, the irradiation sensor 25b, and the temperature sensor 25c. The measurement device 25 may be any measurement device such as a humidity sensor.

### Second Embodiment—Operations

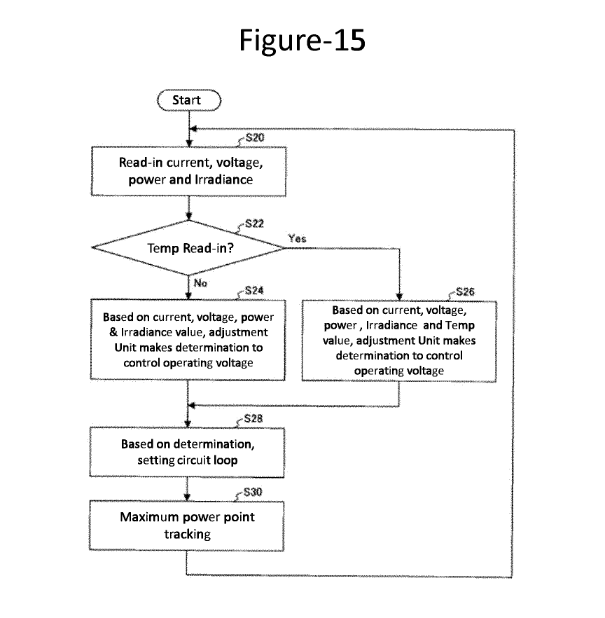

The operations of the MPPT tracking device 2 according to the second embodiment is now described with reference to FIG. 15. FIG. 15 illustrates an example of a maximum power point tracking process (MPPT tracking process) executed by the MPPT tracking device 2 according to the second embodiment.

When the MPPT tracking process starts, the power meter (voltage meter or current meter) 25a detects the power (voltage, or current) output from the PV modules 10. The irradiation sensor 25b detects the irradiation intensity of the sun. The switching unit 27 acquires the results detected by the DC power meter (voltage and/or current and power) 25a or the irradiation sensor 25b (S20). In one example, the values measured may be 1.0 A current, 65 V voltage, 65 W power and a temperature of 35° C.

The switching unit 27 subsequently determines whether the temperature is detectable (S22). If the temperature of the operating PV module is not detectable during the method, the switching unit 27 determines the adjustment unit for adjusting the predetermined operating voltage band based on the acquired power, voltage, current or irradiation intensity (S24) as described above. The switching unit 27 transmits the determined result to the adjustment unit 28 (S28). When the temperature is detectable, the switching unit 27 determines the adjustment unit for adjusting the predetermined operating voltage band based on the acquired power, voltage, current, irradiation intensity or temperature (S26) and the switching unit 27 transmits the determined result to the adjustment unit 28 (S28).

The result may be determined using the knowledge that as temperature rises, the operating voltage drops. Thus, the system, using the amount of temperature drop, predicts a best operating voltage. For example, the operation voltage may be calculated using the following equation:

Voperating=Standard voltage@25° C./{1−dropping ratio %*(Temp,read-in−25° C.)}

wherein Standard voltage @ 25° C. may be 80V and the dropping ratio % is 1%.

Thus, in the example above if the current, voltage and power are normal (which they are in the above example), then the above equation may be used to determine the optimimum operating voltage (S26).

In the method, the adjustment unit 28 switches connections between the first adjustment circuit 281, the second adjustment circuit 282, the third adjustment circuit 283, . . . based on the determined result from the switching unit 27 (S28). This configuration may set the first adjustment circuit 281, the second adjustment circuit 282, the third adjustment circuit 283, or other adjustment circuits so as to shift the operating voltage band of the PV modules 10 by different voltage width (V1>V2>V3). In the example above, if the operating voltage of the PV module(s) is already in the example operating band as above, then no switching is performed. However, if the current operating voltage of the PV module(s) is not in the selected voltage band, then the operating voltage is switched.

The control unit 22 tracks the maximum power point of the PV modules 10 based on the I-V characteristic curve of the PV modules 10 in accordance with the power, voltage or current detected by the power meter (voltage meter or current meter) 25a (S30). The control unit 22 calculates the voltage V closest to the maximum power point Pmax using, for example, the hill climbing method. The control unit 22 outputs the calculated voltage V to the MPPT circuit 20 as an optimal operating point of the PV modules 10. In the example above, the values measured based on the new operating voltage may be 1.0 A current, 75V voltage, 75 W power at 35° C. and thus the PV module(s) are generating 75 W (instead of 65 W) using the new operating voltage.

In operation, the MPPT circuit 20 shifts the voltage band operated by the PV modules 10 by a predetermined voltage (V1, V2, V3, . . . ) that may be set in advance. The voltage V obtained as a result of the maximum power point tracking adjusted by the MPPT circuit 20 fluctuates with a front-end circuit (the operating voltage adjustment unit 5). The control unit 22 constantly adjusts the MPPT circuit 20 to track the maximum power point of the power generated by the PV modules 10. The power supply 21 supplies necessary power for operations of the control unit 22 and the MPPT circuit 20.

The MPPT tracking device 2 according to the second embodiment may repeat the process shown in FIG. 15 based on the irradiation intensity detected by the irradiation sensor 25b, or the temperature detected by the temperature sensor 25c. This tracking device 2 will not restrict the operating voltage band accompanied with tracking the maximum power point within each voltage range to improve the he MPPT tracking efficiency of the PV modules 10.

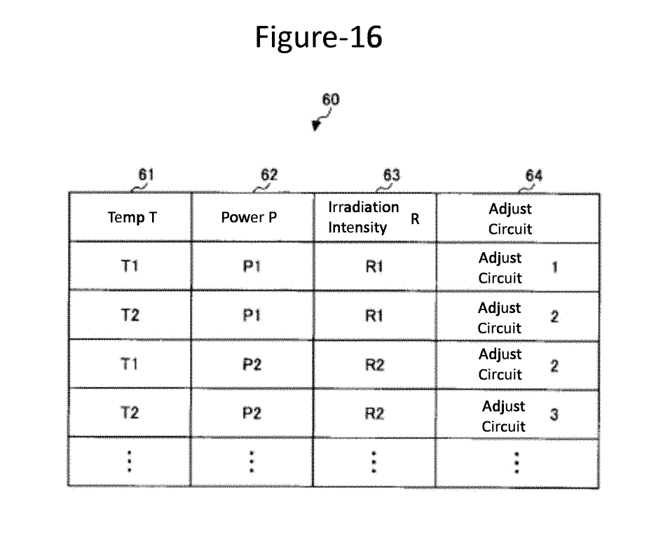

In some embodiments, the MPPT tracking device 2 may have a voltage band selection table 60 as shown in FIG. 16 stored in the MPPT tracking device 2 that has already stored values for the temperature T 61, a power P 62, an irradiation intensity R 63 and a particular adjustment circuit (or value) 64. The voltage band selection table 60 may be used by the switching unit 27 in the above described method to adjust the voltage bands. In some embodiments, the voltage band selection table 60 may be stored in a memory of the MPPT tracking device 2, such as the RAM or other storage. When the embodiment includes the voltage band selection table 60, the switching unit 27 may be able to select a desired adjustment circuit 64 from the voltage band selection table 60 in accordance with the measured temperature T 61, the power P 62 and the irradiation intensity R 63. For example, when the power acquired from the power meter 25a is P1, the switching unit 27 selects an adjustment circuit 1 (having a particular voltage band) stored in association with the power P51 being “P1”. The adjustment circuit 28 connects to the first adjustment circuit 281 to shift the operating voltage of the MPPT circuit 20 by the voltage V1. The switching unit 27 may be able to select a desired adjustment circuit 64 from the voltage band selection table 60 in accordance with the temperature T 61, the power P 62, and the irradiation intensity R 63 in a similar fashion as described above, for example.

Modification—Photovoltaic Power Generation System

The MPPT tracking device 2 according to one modification may include the automatic loading-adjustment unit 4 of the first embodiment and the operating voltage adjustment unit 5 of the second embodiment. The MPPT tracking device 2 according to the modification having such a configuration will restrict neither the loading of the MPPT tracking device 2 (as described above) nor the operating voltage band accompanied with the MPPT tracking (as described above) in each of the voltage ranges, thereby further improving the MPPT tracking efficiency.

### Third Embodiment—Photovoltaic Power Generation System

The MPPT tracking efficiency of the MPPT tracking device 2 will vary with electric conditions of the PV modules 10 or environmental conditions of the PV modules 10. In addition, it may be difficult to specify the MPPT tracking characteristics of the MPPT tracking device 2 that is combined with PV cells having various characteristics. In order to overcome such difficulties, the MPPT tracking device 2 according to a third embodiment is configured to perform simulation based on the electric conditions or the environmental conditions of the PV modules 10.

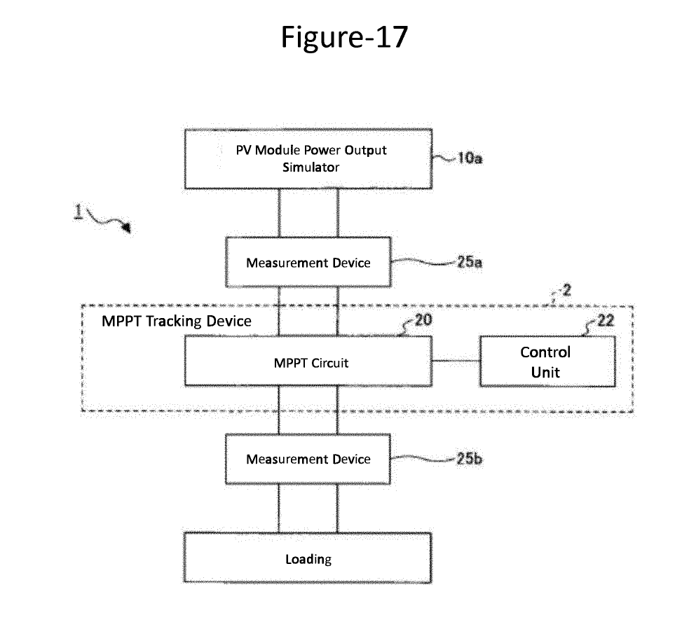

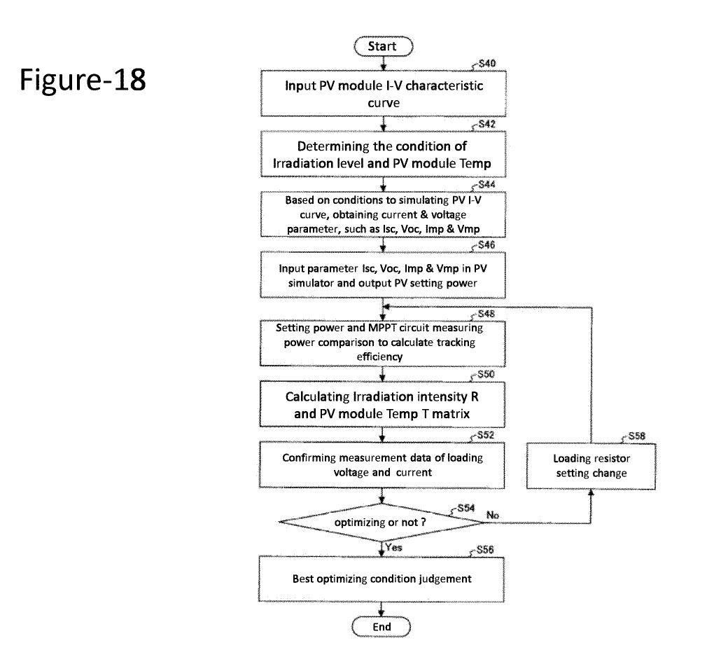

FIG. 17 is a diagram illustrating a configuration example of a photovoltaic power generation system 1 according to the third embodiment. The photovoltaic power generation system 1 according to the third embodiment is used to determine the “resistance of the loading”, the “voltage for switching the loading”, and the like in advance when executing a method for evaluating the PV modules 10. FIG. 18 is a flowchart of a MPPT tracking process illustrating a method for evaluating the PV modules 10 according to this embodiment. In this embodiment, whether the MPPT circuit 20 operates normally may be determined by operating the photovoltaic power generation system 1 in accordance with the MPPT tracking process illustrated in FIG. 18. FIG. 18 specifically illustrates a simulation executed in the order of the following (1) to (8):

(1) Input condition parameters of PV cell data of A company product (I-V characteristic data of the PV cell), the irradiation intensity R, the temperature T into a PV (photovoltaic cell) cell simulator 10a (simulated PV cell output device). The PV cell simulator 10a outputs the power (voltage, current) as a result (see steps S40, S42, S44, and S46). The PV cell simulator 10a calculates a theoretical value of the maximum power (estimated power). The following describes only two products of A company product and B company product as PV cell product examples for simplifying the description; however, it is desirable to have I-V characteristic data of multiple PV cells having various characteristics of other products. Likewise, the following describes examples of various types of tables storing information having I-V characteristic data of the PV cells to which merely the irradiation intensity and the temperature T as examples of environmental conditions for simplifying the illustration. However, the information stored in various types of tables is not limited to the above information. The information stored in various types of tables may preferably be I-V characteristic curve data of different products obtained based on other electric conditions and environmental conditions such as humidity. Various types of tables may be stored in internal memories of the MPPT tracking device 2 or in outside memories connected to the MPPT tracking device 2. Such various types of tables may be complied in a database.

(2) The MPPT circuit 20 performs MPPT tracking by the operations of the control unit 22. Note that the MPPT circuit 20 is connected to the loading based on data acquired from a catalog or the like.

(3) The PV cell simulator 10a acquires the voltages and the currents from measurement devices 25a and 25b.

(4) The PV cell simulator 10a compares the power acquired from the measurement device 25a and the theoretical value of the maximum power to acquire the MPPT tracking efficiency (see step S48 in FIG. 18).

(5) The PV cell simulator 10a evaluates the MPPT tracking efficiency (see step S54 in FIG. 18). The PV cell simulator 10a changes the loading when the MPPT tracking efficiency is not optimal (see step S58 in FIG. 18). The processes subsequent to the process (2) may be executed after the loading is changed.

(6) The PV cell simulator 10a determines the current acquired from the measurement device 25b. The PV cell simulator 10a also changes the loading when the acquired current exceeds 10 A. This is because the current exceeding 10 A will exceed the withstand current (allowable current) of the device or circuit. The processes subsequent to the process (2) may be executed after the loading is changed.

(7) When the acquired current does not exceed 10 A, and the MPPT tracking efficiency is optimal, the PV cell of A company product is evaluated as follows. That is, the MPPT circuit 20 is operating normally with a loading value of the loading at the time being connected under the irradiation intensity R and the temperature T at that time.

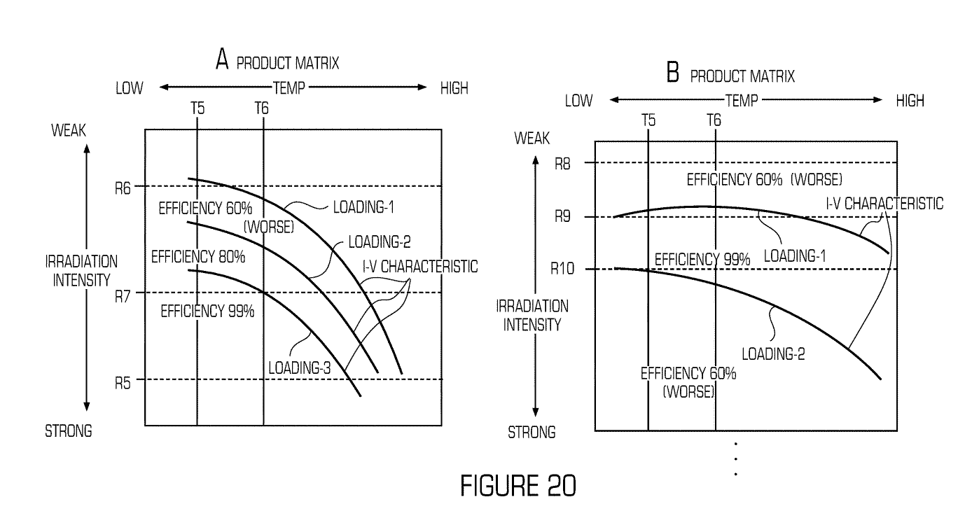

(8) Repeating the above-described operations by altering the conditions such as the temperature T and the irradiation intensity R will clarify the following results. For example, the MPPT tracking efficiency may be optimal when the loading is X1 to X21 within the irradiation intensity range R1 to R2 and within the temperature range T1 to T2. Or the MPPT tracking efficiency may be optimal when the loading is X2 to X3 Ω within the irradiation intensity range R2 to R3 and within the temperature range T2 to T3. FIG. 20 illustrates matrix tables obtained by collecting the above-described information.

Maximum Power Point Tracking Process for Third Embodiment

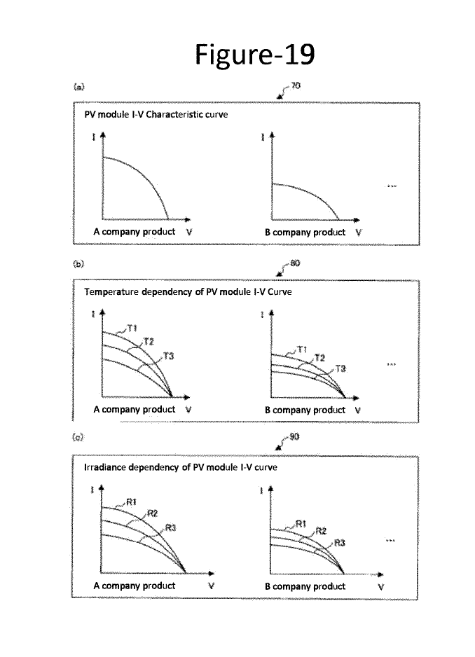

FIG. 18 illustrates a flowchart illustrating the MPPT tracking process. When the MPPT tracking process of FIG. 18 starts, the switching unit 27 acquires the I-V characteristic curve of the PV module 10 of a predetermined product (S40). For example, the I-V characteristic curve of the PV module 10 of each product may be obtained from a corresponding catalog or the like, and the acquired I-V characteristic curve of the PV module 10 may be stored in advance in the product-specific I-V characteristic table 70 in (a) of FIG. 19. To simplify the description, the embodiment illustrates examples of an I-V characteristic curve of the PV module 10 of A company product, and an I-V characteristic curve of the PV module 10 of B company product that are stored in advance in the product-specific I-V characteristic table 70 of the system in FIG. 17 but not shown in the drawings.

The switching unit 27 subsequently determines conditions of the irradiation intensity R and the temperature T of the PV cells (S42) and combined together. The switching unit 27 subsequently calculates parameters (Imp, Isc, Vmp, and Voc) of the I-V (current-voltage) characteristic curve under the determined conditions of the irradiation intensity R and the temperature T (S44). The I-V characteristic curve is specified based on four numerical parameters of Imp, Isc, Vmp, and Voc. Imp denotes maximum operating current, Isc denotes short circuit current, Vmp denotes maximum operating voltage, and Voc denotes open circuit voltage.

The power generation characteristics of “temperature change rate” and the “irradiation intensity change rate” are presented in the PV module 10 catalogs of different manufacturers. Thus, the I-V characteristic change when the temperature changes or when the irradiation intensity changes may be calculated based on the numerical values presented in the catalogs. Thus, (b) of FIG. 19 illustrates A company product-specific temperature dependent I-V characteristic table 80 that stores a temperature dependent I-V characteristic curve of the PV module 10 of A company product, and a temperature dependent I-V characteristic curve of the PV module 10 of B company product. This clarifies that the voltage and current of the PV module 10 vary with temperature.

Similarly, (c) of FIG. 19 illustrates the values that may be stored in a company product-specific irradiance dependent I-V characteristic table 90 that stores an irradiance dependent I-V characteristic curve of the PV module 10 of A company product, and an irradiance dependent I-V characteristic curve of the PV module 10 of B company product. This clarifies that the generated voltage and current of the PV module 10 vary with irradiance (irradiation intensity).

The switching unit 27 subsequently sets the parameters Imp, Isc, Vmp, and Voc calculated into the PV cell simulator 10a (S46). The estimated power of the PV module 10 may be calculated in accordance with the parameters indicating the environmental conditions of the PV module 10, based on a database (a table group) storing the I-V characteristic curves by product of the PV module 10 and by environmental condition.

The switching unit 27 subsequently compares the estimated power of the PV module 10a and the power (tracking power) output from the MPPT circuit 20 into which the estimated value has been input to calculate the power efficiency (S48). The difference between the estimated power and the tracking power will increase when the MPPT circuit 20 does not operate normally. The embodiment employs the maximum power point tracking efficiency (MPPT tracking efficiency) based on the MPPT control in order to evaluate the operating accuracy of the MPPT circuit 20. In other words, the MPPT tracking efficiency based on the MPPT control may be calculated based on the power before passing the MPPT circuit 20 and after passing the MPPT circuit 20.

The switching unit 27 subsequently creates each MPPT tracking efficiency matrix based on the MPPT control in accordance with the corresponding irradiation intensity R, the temperature T, and the loading given, and stores the created matrices in a storage area such as a RAM (S50). An example of the MPPT tracking efficiency matrix is an A company product matrix illustrated in FIG. 20. The A company product matrix illustrates the MPPT tracking efficiency based on the MPPT control in accordance with the irradiation intensity dependency, the temperature dependency, and the loading of the PV cell of A company product. Another example may be a B company product matrix illustrated in FIG. 20. The B company product matrix illustrates the MPPT tracking efficiency based on the MPPT control in accordance with the irradiation intensity dependency, the temperature dependency, and the loading of the PV cell of B company product. The horizontal axis of the matrix indicates the MPPT tracking efficiency change with temperature change, and the vertical axis of the matrix indicates the MPPT tracking efficiency change with irradiation intensity change. These matrices illustrate that I-V characteristic curve may vary with the temperature, irradiation intensity, and the loading.

The switching unit 27 subsequently determines the current and the voltage measured by the loading (S52). More specifically, the switching unit 27 evaluates whether hardware of the PV module 10 has any problem by measuring the voltage and the current. The switching unit 27 also determines whether the PV module 10 exhibits overcurrent or overvoltage, even if the MPPT tracking efficiency is optimal. If the PV module 10 exhibits overcurrent or overvoltage, the PV module 10 may have some damage. Hence, when the PV module 10 has some risk of exhibiting overcurrent or overvoltage, the switching unit 27 subsequently determines that the loading is not optimized (S54).

Thus, the switching unit 27 subsequently determines whether the loading has been optimized (S54). In this process, the switching unit 27 determines that the loading has been optimized when the MPPT tracking efficiency is 99% or above. Further, the switching unit 27 determines that the loading has not been optimized when the MPPT tracking efficiency is lower than 99%.

The switching unit 27 determines that a value of a certain loading, and the temperature T and the irradiation intensity R of the PV cell when the loading is connected to the PV cell are the optimal conditions of the MPPT tracking efficiency obtained by the MPPT circuit 20, and subsequently ends the MPPT tracking process (S56). As a result, the value of the certain loading, and the optimal temperature T and irradiation intensity R of the PV cell when that loading is connected to the PV cell may be obtained. In addition, the temperature range and irradiation intensity range for each of the predetermined loadings in which the MPPT tracking efficiency reaches 99% or above may be obtained. In this case, the switching unit 27 changes the setting value of the loading (S58), and perform processes S48 to S54 until the MPPT tracking efficiency achieves 99% or above.

In A company product matrix illustrated in FIG. 20, for example, the loading 3 that exhibits the MPPT tracking efficiency of 99% or above may be determined to be optimal when the temperature T falls within the temperature range T5 to T6, and the irradiation intensity R falls within the irradiation intensity range R5 to R7. On the other hand, any of the loadings 1 to 3 that exhibit the MPPT tracking efficiency of lower than 99% may be determined to be not optimized when the temperature T falls within the temperature range T5 to T6, and the irradiation intensity R falls within the irradiation intensity range R5 to R7.

Similarly, in B company product matrix illustrated in FIG. 20, the loading 1 and 2 that exhibit the MPPT tracking efficiency of 99% or above may be determined to be optimal when the temperature T falls within the temperature range T5 to T6, and the irradiation intensity R falls within the irradiation intensity range R5 to R7.

Based on the results of the above-described flow, the optimal loading may be implemented in the MPPT tracking device 2 according to the first embodiment or the MPPT tracking device 2 according to the second embodiment. In order to operate the MPPT tracking device 2, the control unit may have programs installed (or mechanical relay circuits or the like) for appropriately switching the loading to the optimal one based on the voltage output from the PV cell, or based on the environmental conditions such as the temperature or irradiation intensity to operate the MPPT tracking device 2. As described above, the MPPT tracking device 2 according to the third embodiment may be able to improve the MPPT tracking efficiency based on the electric conditions or the environmental conditions of the PV module 10.

The evaluation level (acceptance level) of the MPPT tracking efficiency is determined as 99% in the above examples; however, the evaluation level may be optionally set according to a desired requirement. Further, the above examples optimized the MPPT tracking efficiency by changing the loading; however, the MPPT tracking efficiency may be optimized by changing the voltage band, or the MPPT tracking efficiency may be optimized by changing both the loading and the voltage band. The above-described embodiments and examples employ multiple PV cells, however, the embodiments and examples may employ a single PV cell.

### Fourth Embodiment—Photovoltaic Power Generation System

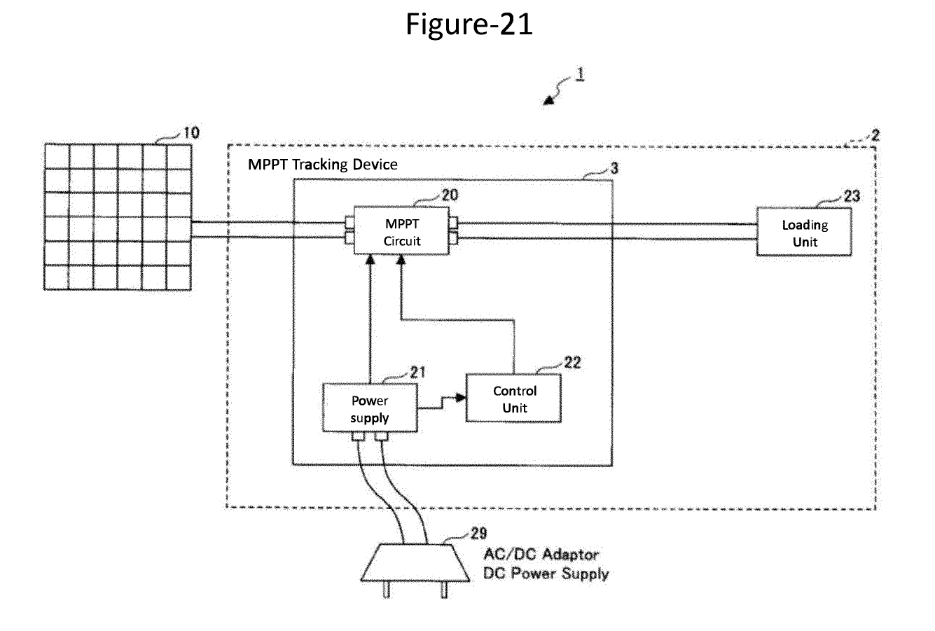

FIG. 21 is a diagram illustrating a configuration example of a photovoltaic power generation system 1 according to a fourth embodiment. The MPPT tracking device 2 according to the fourth embodiment may be able to prevent the MPPT tracking efficiency from lowering caused by the internal configuration of the MPPT tracking device 2 such as an electronic circuit design, unstable power supply or internal loss.

The MPPT tracking device 2 according to the fourth embodiment is connected to a DC voltage power source 29 configured to stably feed the power supply 21 from outside of the PV power generation system 1. The DC voltage power source 29 is an example of a non-charge battery type outside power source. The DC voltage power source 29 is configured to supply direct current electricity and perform AC/DC conversion. This configuration may stably supply electric power necessary for the control unit 22 and MPPT circuit 20 from the DC voltage power source 29 disposed outside to the power supply 21. The MPPT tracking device 2 according to the fourth embodiment may thus be able to prevent the MPPT tracking efficiency from lowering caused by the internal configuration of the MPPT tracking device 2 such as an electronic circuit design, unstable power supply or internal loss. In other words, the DC voltage power source 29 may preferably be used under the environment in which the irradiation intensity is low and the temperature is low.

Experiments and Simulation Results

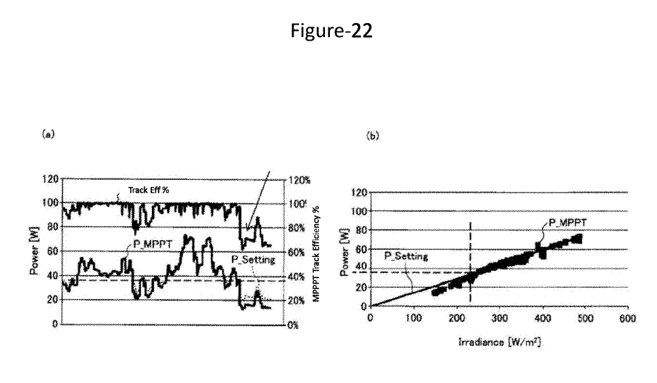

Experiments and simulation results obtained in the above-described first to fourth embodiments (including modifications) are now described with reference to FIGS. 22 to 27.

Auto-Loading: Automatic Loading Adjustment

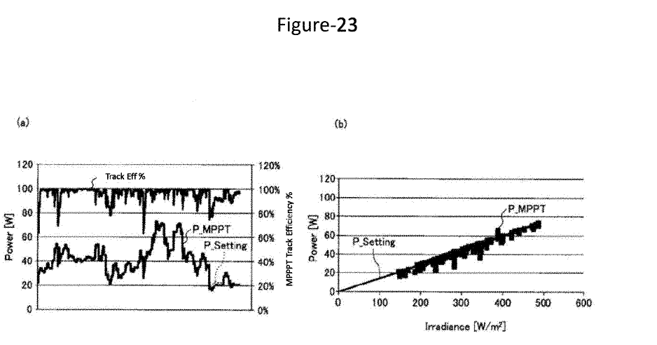

Initially, an illustrating is given of an example of the auto-loading (automatic loading adjustment) relating to the first embodiment. FIG. 23 illustrates examples of advantageous effects provided by the automatic loading-adjustment unit 4 of the MPPT tracking device 2 according to the first embodiment, and FIG. 22 illustrates comparative examples effects provided by the MPPT tracking device 2 without disposing the automatic loading-adjustment unit 4. The MPPT tracking device 2 without the automatic loading-adjustment unit 4 exhibits low MPPT tracking efficiency under the low irradiation intensity condition, as illustrated by the power illustrated by an arrow of (a) and the power illustrated below a broken line (b) of FIG. 22. By contrast, the MPPT tracking device 2 according to the first embodiment having the automatic loading-adjustment unit 4 is capable of improving the MPPT tracking efficiency under the low irradiation intensity condition, as illustrated in (a) and (b) of FIG. 23.

Voltage Trimming: Adjustment of Operating Voltage Band

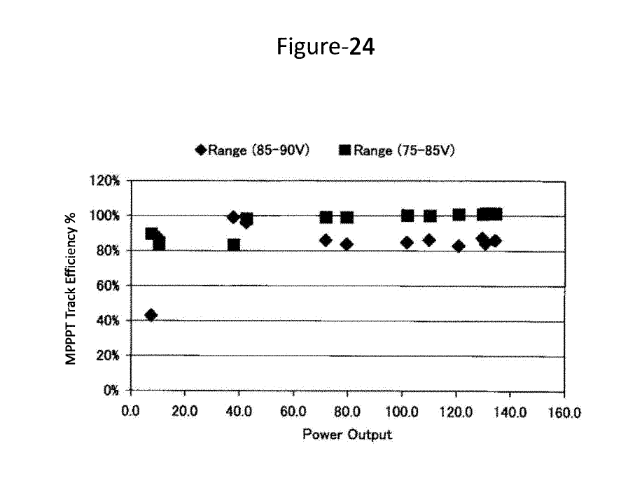

Next, an illustration is given of an example of voltage trimming (adjustment of an operating voltage band) relating to the second embodiment. FIG. 24 is a graph illustrating an example of an advantageous effect provided by the operating voltage adjustment unit 5 of the MPPT tracking device 2 according to the second embodiment. The results of FIG. 24 are obtained based on the example of the PV module 10 having the voltage Vmp of 78 V. When the operating voltage band adjusted by the operating voltage adjustment unit 5 is set in a range of 75 to 85 V, the MPPT tracking efficiency is approximately maintained at 99% or above. On the other hand, when the operating voltage band adjusted by the operating voltage adjustment unit 5 is set in a range of 85 to 95 V, the MPPT tracking efficiency lowers. These results suggest that the MPPT tracking efficiency may be improved by adjusting the operating voltage band in accordance with the output voltage of the PV module 10.

MPPT Tracking Ability Compensation: MPPT Tracking Efficiency Compensation

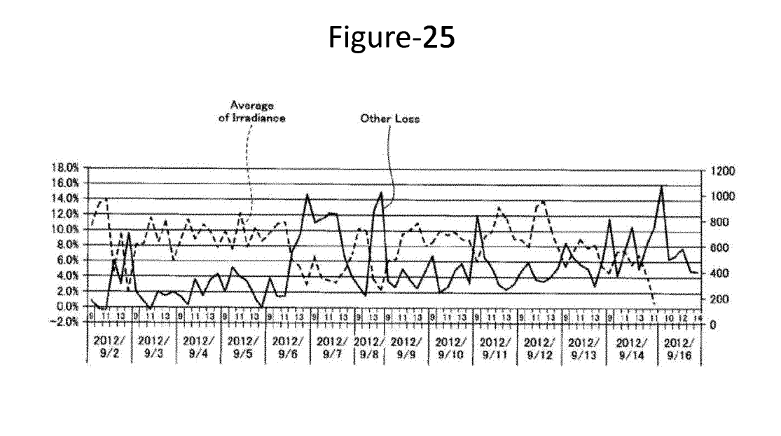

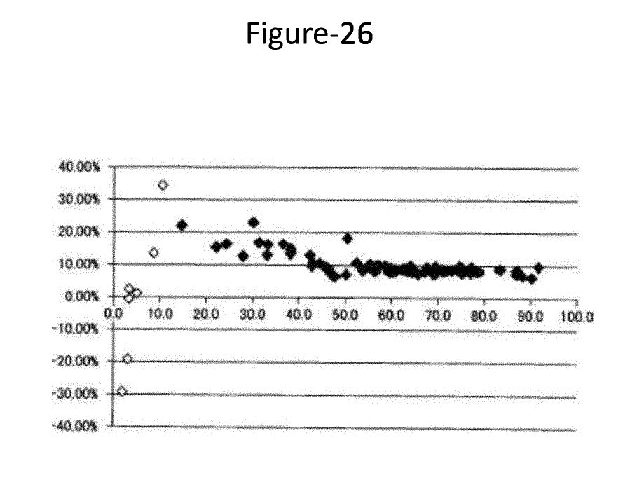

Next, an illustration is given of an example of MPPT tracking ability compensation (MPPT tracking efficiency compensation) relating to the third embodiment. FIG. 25 is a graph illustrating an example of a loss value of the maximum power point tracking efficiency. FIG. 26 is a graph illustrating an example of an advantageous effect relating to the MPPT tracking ability compensation (MPPT tracking efficiency compensation).

The vertical axis on the left of FIG. 25 indicates a loss value of the MPPT tracking efficiency, the horizontal axis indicate time (one graduation indicates 1 hour), and the vertical axis on the right indicates the mean (average)) irradiation intensity per graduation and per hour. FIG. 25 illustrates an example that increases the loss value of the MPPT tracking efficiency as the irradiation intensity indicated by the broken line weakens, illustrating the degradation of the MPPT tracking efficiency. This test is conducted based on data obtained by the PV module simulator, and the loss value of the MPPT tracking efficiency may be accurately calculated.

The vertical axis of FIG. 26 indicates a compensation value of the MPPT tracking efficiency, and the horizontal axis indicate output power of the PV module. FIG. 26 illustrates the degradation of the MPPT tracking efficiency as the PV module lowers. These results suggest that the maximum power point may be obtained by the “output power of the PV module×(1+compensation value %)”.

Non-Charge Battery Type Outside Power Source

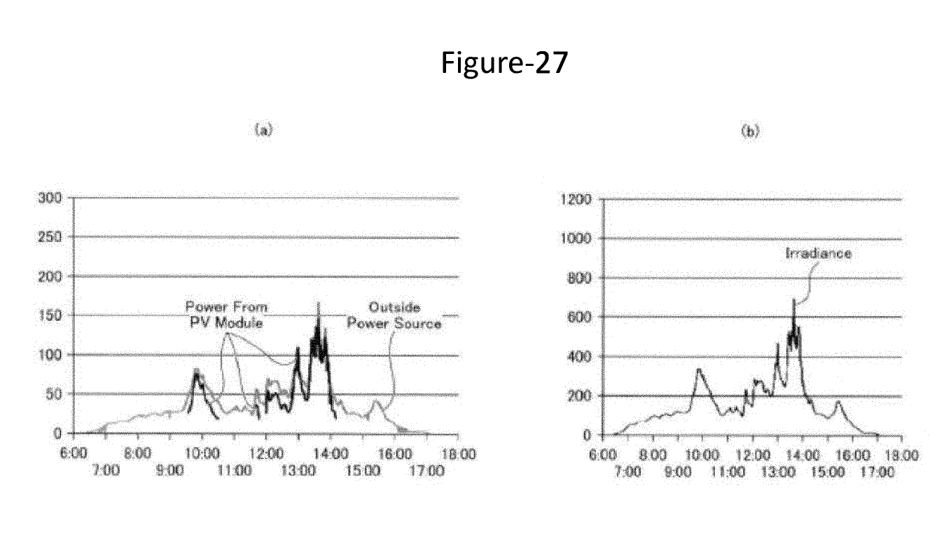

The final illustration is given of an example of non-charge battery type outside power source relating to the fourth embodiment. The irradiation intensity per hour is illustrated in (b) of FIG. 27. The output of the outside power source and the output power of the PV module per hour are illustrated in (a) of FIG. 27. These results suggest that excellent MPPT tracking efficiency is obtained by stably supplying power necessary for the control unit 22 and MPPT circuit 20 from the outside power source.

The above-described embodiments and modifications may provide relatively simplified and compact device and method for obtaining conditions for tracking a more accurate maximum power point, and may thus be preferably applied for evaluating the PV module. The above-described embodiments and modifications may be able to accurately evaluate performance of the PV module under various environmental conditions without being affected by the characteristics of the MPPT circuit. Further, the above-described embodiments and modifications may be able to monitor or estimate electric power generation of the PV modules by connecting the MPPT tracking device 2 to part of PV modules 10 under the environment such as using multiple PV cells such as a photovoltaic power plant. Specifically, the above-described embodiments and modifications may preferably be employed under the severe environmental conditions such as desert regions, cold districts, and districts located at a high latitude.

The embodiments of the disclosure are described above. However, the disclosure is not limited to the above-described specific embodiments, and variations and modifications may be made within the scope of the claims. The disclosed embodiments may be combined with consistency.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that performs particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A maximum power point tracking (“MPPT”) device comprising:
an MPPT control unit configured to track a maximum power point with respect to one of voltage, current, and power to control a corresponding one of the voltage, current, and power according to the tracked maximum power point; and
an adjustment unit configured to adjust a loading value connected to the MPPT device in response to a measured value measured during an operation of a photovoltaic module or within an environment of the photovoltaic module so that the MPPT control unit efficiently tracks the maximum power point during different conditions of the operation of the photovoltaic module or within different conditions of the environment of the photovoltaic module.

2. A maximum power point tracking (“MPPT”) device comprising:
an MPPT control unit configured to track a maximum power point with respect to one of voltage, current, and power output by a photovoltaic module, and control a corresponding one of the voltage, current, and power according to the tracked maximum power point; and
an adjustment unit configured to adjust a loading value connected to the MPPT device in response to a measured value measured during an operation of a photovoltaic module or within an environment of the photovoltaic module so that the MPPT control unit efficiently tracks the maximum power point during different conditions of the operation of the photovoltaic module or within different conditions of the environment of the photovoltaic module.

3. The maximum power point tracking device as claimed in claim 1, wherein the measured value in association with the operation or the environment of the photovoltaic module includes at least one of measured values of the voltage, the current and the power output by the photovoltaic module, or one of measured values of irradiation intensity and temperature, and wherein the adjustment unit includes a switching unit configured to acquire the at least one of the measured values to switch the loading value connected to the MPPT control unit to a loading value according to the acquired measured value.

4. A maximum power point tracking (“MPPT”) device comprising:
an MPPT control unit configured to track a maximum power point with respect to one of voltage, current, and power output by a photovoltaic module, and control a corresponding one of the voltage, current, and power according to the tracked maximum power point; and
an operating voltage adjustment unit configured to adjust an operating voltage band in response to a measured value measured during an operation of a photovoltaic module or within an environment of the photovoltaic module so that the MPPT control unit efficiently tracks the maximum power point during different conditions of the operation of the photovoltaic module or within different conditions of the environment of the photovoltaic module.

5. The MPPT device as claimed in claim 4, wherein the measured value in association with the operation or the environment of the photovoltaic module includes at least one of measured values of the voltage, the current and the power output by the photovoltaic module, or one of measured values of irradiation intensity and temperature, and wherein the operating voltage adjustment unit includes a switching unit configured to acquire the at least one of the measured values to switch the operating voltage band connected to the MPPT control unit to an operating voltage band according to the acquired measured value.

6. A maximum power point tracking device comprising:
an MPPT control unit configured to track a maximum power point with respect to one of voltage, current, and power output by a photovoltaic module, and control a corresponding one of the voltage, current, and power according to the tracked maximum power point;
an adjustment unit configured to adjust a loading value according to a measured value measured during an operation of a photovoltaic module or within an environment of the photovoltaic module so that the MPPT control unit efficiently tracks the maximum power point during different conditions of the operation of the photovoltaic module or within different conditions of the environment of the photovoltaic module; and
an operating voltage adjustment unit configured to adjust an operating voltage band according to a measured value in association with an operation or an environment of the photovoltaic module for the MPPT control unit to track the maximum power point.

7. The maximum power point tracking device as claimed in claim 6, wherein the switching unit calculates estimated power of the photovoltaic module according to the measured value in association with the environment of the photovoltaic module, based on a database indicating current characteristic and voltage characteristic by product of the photovoltaic module and by condition of the environment stored in advance, and
the switching unit switches the loading value connected to the MPPT control unit according to a power efficiency calculated based on the calculated estimated power and power calculated by causing the MPPT control unit to track the maximum power point.

8. The maximum power point tracking device as claimed in claim 7, further comprising:
an outside power source connected to the MPPT control unit, and configured to supply electric energy to the MPPT control unit.

9. A photovoltaic power generation system comprising:
at least one photovoltaic module; and
a maximum power point tracking (“MPPT”) device connected to the photovoltaic module, wherein the maximum power point tracking device includes:
an MPPT control unit configured to track a maximum power point with respect to one of voltage, current, and power output by the photovoltaic module, and control a corresponding one of the voltage, current, and power according to the tracked maximum power point; and
an adjustment unit configured to adjust at least one of a loading value and an operating voltage band according to a measured value measured during an operation of a photovoltaic module or within an environment of the photovoltaic module so that the MPPT control unit efficiently tracks the maximum power point during different conditions of the operation of the photovoltaic module or within different conditions of the environment of the photovoltaic module.

10. A method for evaluating a photovoltaic module based on the photovoltaic module and a loading connected to the photovoltaic module via a maximum power point tracking device, the method comprising:
tracking a maximum power point to control power from the photovoltaic module to achieve a maximum power value;
acquiring a value measured during an operation of a photovoltaic module or within an environment of the photovoltaic module; and
controlling a voltage input into or output from the maximum power point tracking device, according to the value measured during the operation of the photovoltaic module or within the environment of the photovoltaic module.

11. The method as claimed in claim 10, wherein the controlling the voltage includes adjusting a value of a loading connected via the maximum power point tracking device.

12. The method as claimed in claim 11, wherein the controlling the voltage includes adjusting a voltage band input into the maximum power point tracking device.
